(19) United States
(12) Patent Application Publication
(10) Pub. No.: US 2021/0222817 A1
(43) Pub. Date: Jul. 22, 2021

(54) DRY PIPE REHABILITATION SPINCASTER

(71) Applicant: Action Products Marketing, LLC, Johnston, IA (US)

(72) Inventors: Keith WALKER, Johnston, IA (US); Colin MELTON, West Des Moines, IA (US); Dan JURY, Ankeny, IA (US)

(21) Appl. No.: 17/153,035

(22) Filed: Jan. 20, 2021

Related U.S. Application Data
(60) Provisional application No. 62/963,400, filed on Jan. 20, 2020.

(51) Int. Cl. F16L 55/1645

(52) U.S. Cl. CPC F16L 55/16455; E03F 2003/065

(57) ABSTRACT

A remotely controllable pipe rehabilitation device having a base, a water opening, a dry pipe rehabilitation material opening, a first pipe rotatably attached to the base and coupled to the dry pipe rehabilitation material opening, a motor, a drive member coupled to the motor and the first pipe, a rotatable delivery pipe located adjacent to a first portion of the base and coupled to the first pipe and having a nozzle, a water with a water outlet to rotate with the nozzle, a first hose from the first water opening to the second water opening, a second hose from the water outlet to the nozzle, and a remote control disposed remotely from the area to be rehabilitated, the remote control to allow a user to operably maneuver the motor into a desired lateral orientation.

### CROSS-REFERENCE TO RELATED APPLICATION(S)

This application claims priority to and benefit of U.S. Provisional Application Ser. No. 62/963,400, filed on Jan. 20, 2020, entitled “DRY PIPE REHABILITATION SPINCASTER” the disclosure of which is hereby incorporated herein by reference in its entirety.

### BACKGROUND

Over time, culverts and sanitary sewer pipes deteriorate due to numerous factors. For example, corrugated metal pipes commonly used for culverts rust and buckle, and typically have a design life of 40-50 years. There are several options for replacement or repair of deteriorated pipes. One option is pipe replacement, which requires digging, and in the case of under the road culverts, the road must be closed for excavation and laying of the new pipe. Another option is slip lining of the existing pipe, which often reduces the capacity by one-third or more. A third option is cured-in-place pipe (CIPP) liners, which can be expensive in large diameters or non-round shapes.

A fourth option for repairing deteriorated culverts and sewer pipes is centrifugally cast concrete pipe (CCCP). U.S. Pat. No. 5,452,853 issued on Sep. 26, 1995, which is hereby expressly incorporated by this reference, generally discloses the CCCP process. The centrifugally cast concrete pipe rehabilitation method applies thin layers of a coating such as structural grout, epoxy mortar, or polymer coating to produce a smooth, tightly bonded, waterproofed finished product which does not significantly reduce the inner diameter of the pipe or culvert. Thus, after repair the flow through the pipe or culvert is substantially the same as (or sometimes even better than) with the original pipe.

One CCCP process includes mixing the dry pipe rehabilitation coating material with a liquid, such as water, to begin the curing process then pumping the wetted material through a hose to a device, such as a spin caster device, that centrifugally spray the wetted material onto the pipe walls. The casting head moves through the pipe at a calculated speed to centrifugally cast the coating material evenly around the interior of the pipe to form a liner or coating. One problem with this method is that pumping the wetted rehabilitation coating material over a long distance is difficult and causes problems. The coating material is viscous and becomes more viscous the longer it travels through the hose because it continues to cure as it travels. The pressure necessary to pump the material increases to a point where it is not feasible to pump the material over a certain distance. This is especially problematic when rehabilitating long pipes.

Existing CCCP devices have nozzles which continuously rotate 360 degrees to spray material around the entire inner surface of the pipe. This works well when the entire inner pipe wall is uniform and requires rehabilitation. However, if only a portion of the pipe needs to be fixed (e.g., the top of the pipe) or if one portion of the pipe needs to be sprayed longer than another portion of the pipe (e.g., when trying to make a corrugated pipe have a constant diameter), then existing devices and methods are ineffective and/or unnecessarily waste material.

There is therefore a need for a device and method which overcomes these and other drawbacks in the art.

### SUMMARY

One aspect of the present disclosure includes a controllable pipe rehabilitation device having a base. Attached to the base is a first water inlet and a dry pipe rehabilitation material inlet configured to receive a dry pipe rehabilitation material. A hollow pipe is attached to the base and coupled to the dry pipe rehabilitation material inlet to guide rehabilitation material from the inlet through the base. The device has a rotatable delivery pipe coupled to the hollow pipe and has a nozzle. A motor is attached to the base and configured to controllably rotate the rotatable delivery pipe. The rotatable delivery pipe is configured to rotated 360 degrees relative to the base to spray material around the circumference of the pipe wall. A union is attached between the base and the nozzle, the union includes a stationary water inlet and a water outlet to rotate with the rotatable delivery pipe. A first hose guides water received at the first water inlet to the stationary water inlet, and a second hose rotates with the rotatable delivery pipe and guide water from the water outlet to the rotatable delivery pipe. The second hose introduces and mixes water with the dry rehabilitation material within the rotatable delivery pipe.

Another aspect of the present disclosure includes a device for applying a pipe rehabilitation material. The device includes a pipe connected to a source of dry pipe rehabilitation material and guides dry pipe rehabilitation material through the device. A delivery pipe is coupled to the front end of and is rotatable with the drive shaft, the delivery pipe including a nozzle. A motor is coupled to the delivery pipe to controllably rotate the delivery pipe. The rotatable delivery pipe is configured to rotate 360 degrees relative to the base to spray material around the circumference of the pipe wall. A union with a fixed portion and a rotatable portion is attached to the device and the rotatable portion rotates with the delivery pipe. A water inlet on the stationary portion of the water union connects to a source of water. A water outlet is on the rotatable portion of the water union. A hose with a hose inlet connects to the water outlet and has a hose outlet that connects to the delivery pipe and introduces water to the amount of dry rehabilitation material.

Yet another aspect of the present disclosure includes a method of applying a pipe rehabilitation material to the inside of a pipe. The method includes blowing a dry pipe rehabilitation material into a rotatable delivery pipe using pressurized air. Then wetting the dry pipe rehabilitation material by combining a fluid (like water) with the dry pipe rehabilitation material within the rotatable delivery pipe. The delivery pipe can then be controllably rotated by a motor disposed on a frame of a rehabilitation device. Then the wetted pipe rehabilitation material may be controllably applied to the inside of the pipe.

Still another aspect of the present disclosure includes a remotely controllable pipe rehabilitation device. The device includes a base, a first water inlet configured to receive water from a water source, and a dry pipe rehabilitation material inlet configured to receive a dry pipe rehabilitation material. A rotatable delivery pipe may be coupled to the hollow pipe and have a nozzle to deliver a mix of the water from the water source and the dry pipe rehabilitation material from the dry pipe rehabilitation material inlet to a portion of a pipe needing rehabilitation. A union on the base delivers dry pipe rehabilitation material from the dry pipe rehabilitation material inlet and water from the water source to the rotatable delivery pipe. A motor controllably rotates the rotatable delivery pipe. The motor rotational speed and direction of rotation may each be controllable by a user control at a location remote from the portion of a pipe needing rehabilitation. For instance, a user may use the remote control to adjust the orientation of the delivery pipe to spray more rehabilitation material in certain areas of a pipe to be repaired than others. The user may also slow the speed of the rotation of the delivery pipe to spray in lower areas of the pipe to be repaired than in others, building up more of the rehabilitation material in these areas to affect a smooth, uniform finish.

As will be discussed in detail below, in the process of the present disclosure, a wet curing agent, such as water or other fluid is not introduced to the pipe coating rehabilitation material until the material reaches the nozzle of the machine. The material may be a cementitious material, polymer, curing agent, antibacterial agent, or other suitable material or combination of materials. In some embodiments the material is dry before being mixed with the wet curing agent (e.g. water or any other wet curing agent known in the art) that beings the curing process. The dry material and the wet curing agent are pumped separately to the rehabilitation device where they are mixed then sprayed onto the pipe wall. The dry material and wet curing agent may be mixed downstream from the union in the rotatable delivery pipe. In one embodiment the material is mixed with the wet curing agent at the nozzle. In some embodiments the nozzle is remotely controlled such that a user, using a camera located on the machine and with a remote monitor in a location convenient for the user, can direct the rotatable delivery pipe to any angle around the 360-degree circumference of the pipe. In this manner the user can spend more time rehabilitating lower or more heavily damaged areas longer and higher or less damaged areas shorter such that the end product is a smooth pipe without the imperfections that are present in the un-rehabilitated pipe. In certain cases, it is desirable for the user to not enter the pipe, such as when the pipe is too small for a user to enter, and this remote controllability allows the user to remotely control all aspects of the rehabilitation process from a location that is remote from the area being rehabilitated. The resulting coating may form a thick structural layer or a thin protective layer on the inside surface of the pipe.

These and other aspects, objects, and features of the present disclosure will be understood and appreciated by those skilled in the art upon studying the following specification, claims, and appended drawings.

### BRIEF DESCRIPTION

In the drawings:

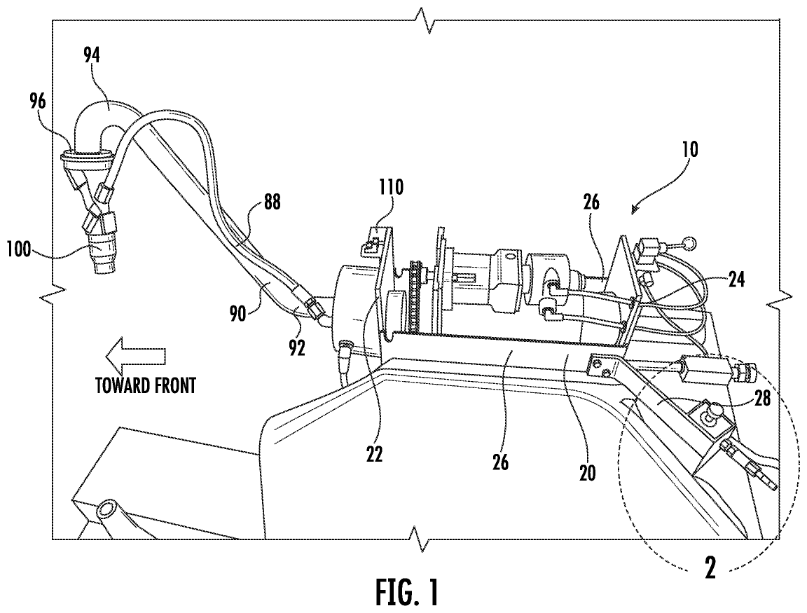

FIG. 1 is an elevated side view of an embodiment of the pipe rehabilitation device.

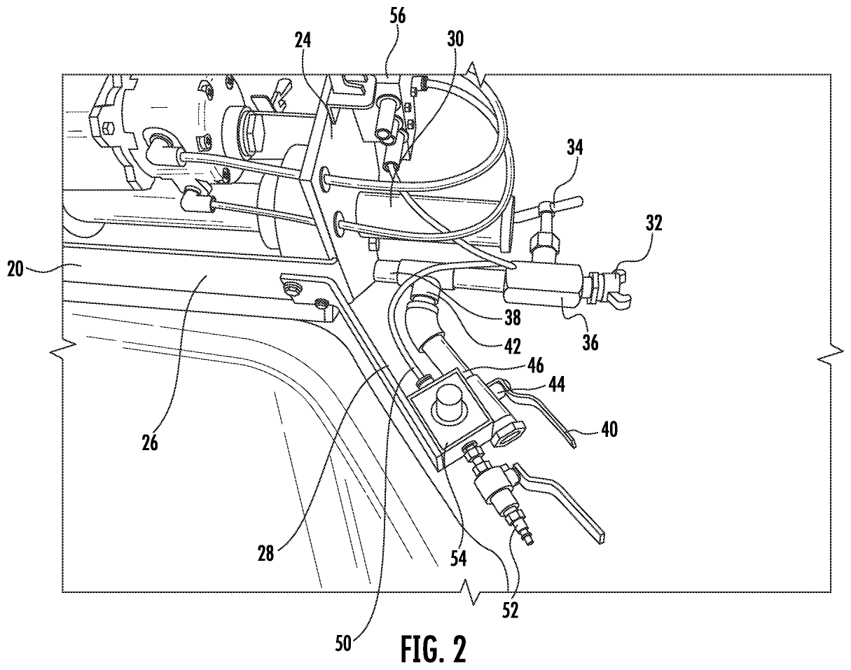

FIG. 2 is an elevated side view of the rear portion of an embodiment of the device.

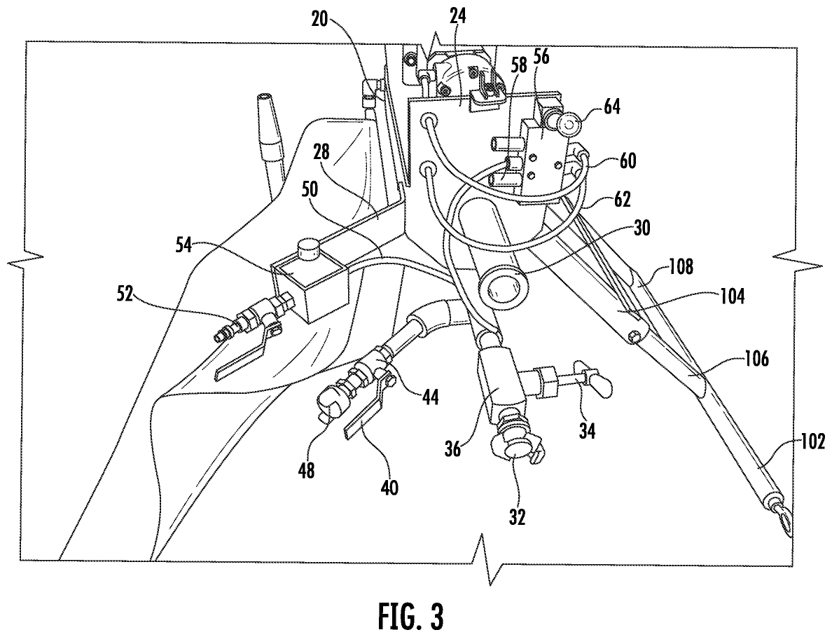

FIG. 3 is an elevated rear view of an embodiment of the device.

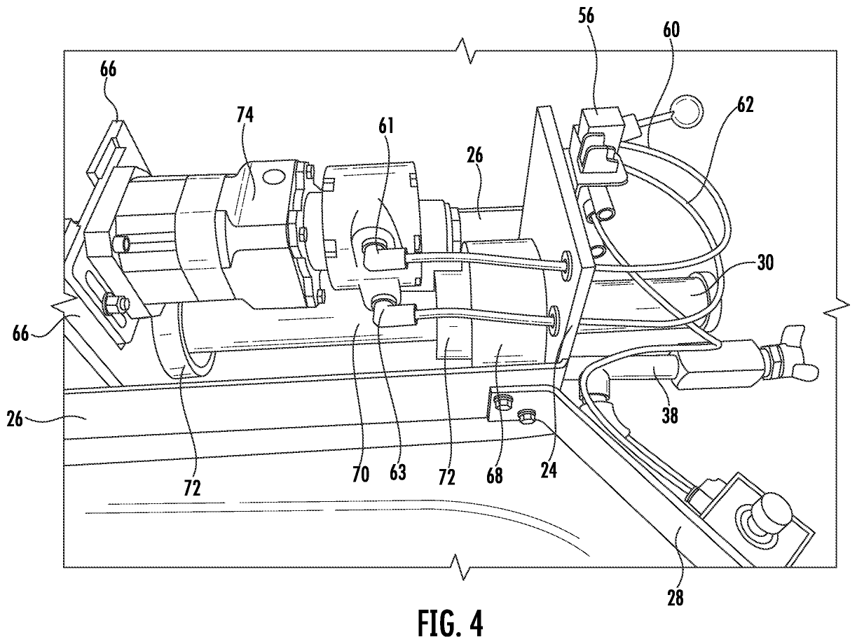

FIG. 4 is an elevated side close-up view of the motor and its attachments of an embodiment of the rehabilitation device.

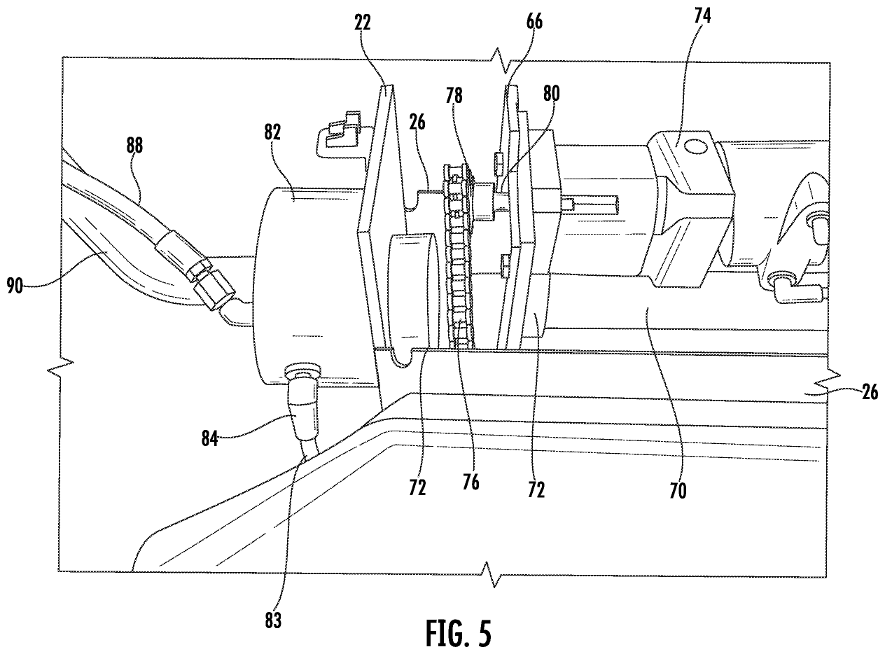

FIG. 5 is another elevated side close-up view of the motor and its attachments of an embodiment of the rehabilitation device.

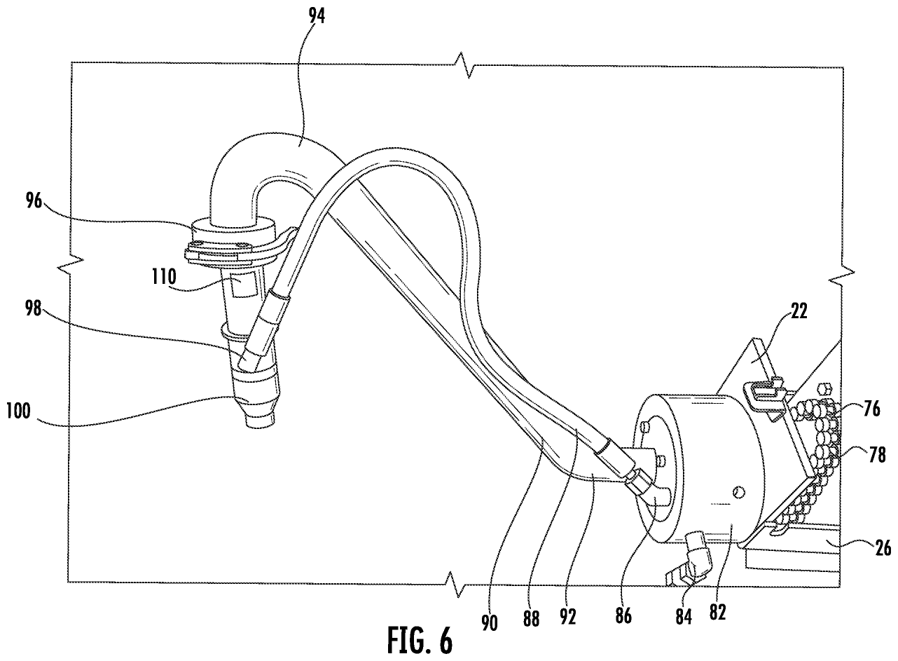

FIG. 6 is an elevated side view of the front material delivery portion of an embodiment of the rehabilitation device.

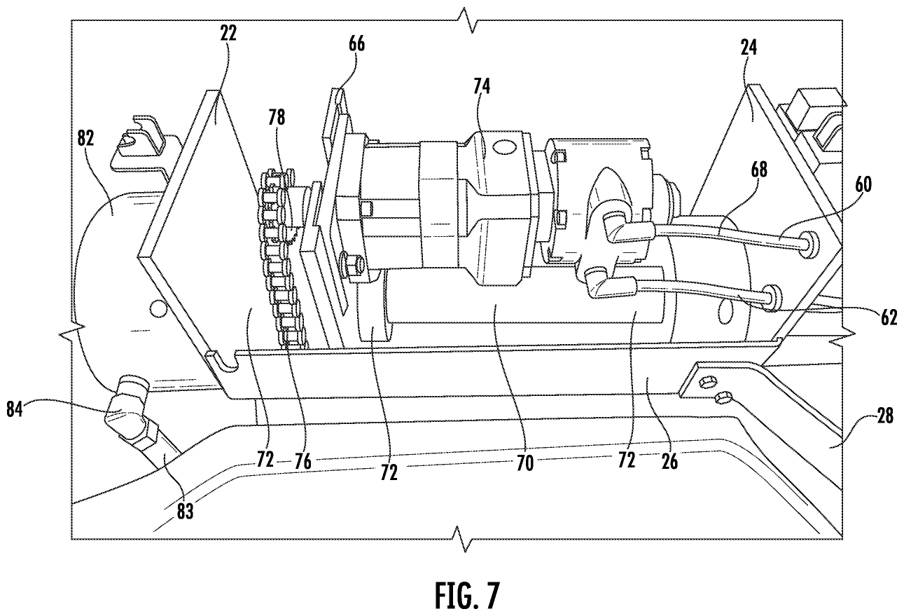

FIG. 7 is yet another elevated side close-up view of the motor and its attachments of an embodiment of the rehabilitation device.

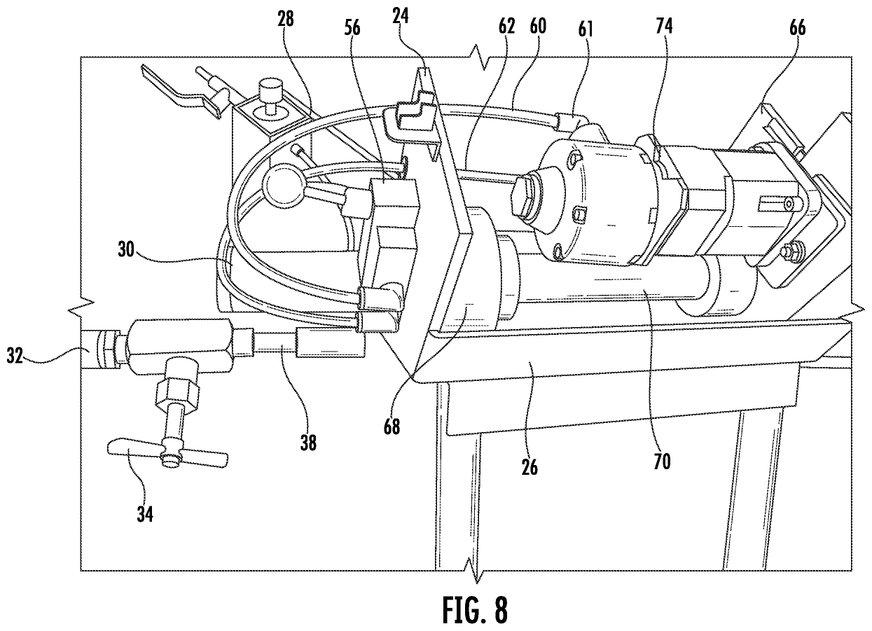

FIG. 8 elevated side close-up view of the motor and its attachments from the opposite side of an embodiment of the rehabilitation device.

### DETAILED DESCRIPTION

FIG. 1 shows the rehabilitation device 10 from an elevated side view, with the front of the machine facing to the left (as shown by the arrow). The device 10 may include a base or housing 20. The base 20 may include front and rear base plates 22, 24. The base 20 may also include side plates 26. An angled extension plate 28 may also be included to help support some of the external components. While the extension plate 28 is shown extending at an angle to the left and rear of the base 20, it should be known that this plate 28 may comprise more than one plate, or may be coupled to the base 20 at any location that is convenient for support of pipes and other components given the pipe dimensions, water inlet locations, and pipe rehabilitation material inlets.

FIGS. 2 and 3 show a rear portion of the rehabilitation device 10. A dry material inlet pipe 30 extends from the base 20 and provides a conduit for dry material to enter the device 10 and be directed toward the nozzle. There is a water inlet pipe 38 that provides a conduit for fluid to enter the device 10 and be directed toward the nozzle. The water inlet pipe 38 includes an inlet fitting 32 and may include a valve 36 with a valve handle 34 to control the amount of water (or other fluid) entering the device 10. In another embodiment, the control of the amount of water or other fluid is controlled by the user from the remote location outside of the pipe, and may not include the valve 36. In another embodiment, a flow meter is attached to the water inlet 38. In still another embodiment, the water flow meter is attached at a source of pressurized water and may be electrically connected to a monitor and easily accessible to a user while the device is in use. In certain embodiments, a second water or other fluid inlet pipe 46 may junction with the water inlet pipe 38 at a t-junction 42. The second pipe 46 may also include an inlet fitting 48 and valve 44 with valve handle 40. The second inlet pipe 46 may be used as a second water inlet for increased water volume, or may be used to introduce chemicals or other materials to aid the rehabilitation mixture in curing, strength, or any other rehabilitation parameter.

An air line 50 may also be located on the rear of the base 20. The air line may include a pneumatic attachment 52 and a valve 54 to control air that is used to control the motor (discussed below). A manifold 56 may be located on the back plate 24 of the base 20. The manifold 56 may include an inlet line 58 that is attached to or integral with the air line 50, and a pair of outlet lines 60, 62 that are coupled to the motor 74. A handle 64 may control the flow of air or other fluid from the inlet line 58 to one, both, or neither of the outlet lines 60, 62, and in this way control the direction and speed of the motor. The control 64 may also be located at a remote location, allowing the user to control the motor 74 without entering the pipe that is being rehabilitated.

Looking at FIG. 4, the motor 74 is coupled to the base 20 through an attachment plate 66. The motor 74 may be a pneumatic motor or any other motor known in the art that includes the ability to control both speed and direction of the delivery pipe, and by extension the speed and direction of the nozzle 100. The motor controls the nozzle orientation and angular speed of the nozzle to better control the placement of the pipe rehabilitation material to the underground pipe wall that may not be uniform in thickness, depth, or need for material application. For instance, in pipes that have corrugation, it may be desirable to hold the nozzle in a certain position for longer to fill in the lower portions of the underground pipe. In this way, the entire rehabilitation process may be accomplished in a single run through the pipe, as opposed to multiple runs typically necessary for a typical device to apply the rehabilitation material to fill in low portions.

As shown, the outlet lines 60, 62 extend from the manifold 56 through the back plate 24, and to the motor 74 at motor inlets 61, 63. Depending on the incoming air differential in the air lines 60, 62, the motor may be controlled to spin in either direction and at speeds desired by the user. The air differential in air lines 60, 62 may be controlled by the handle 64, or at a location that is remote from the area being rehabilitated, such as outside of the pipe altogether. The attachment plate 66 is shown as welded to the base 20 at the side walls 26, but may be attached in any other way known in the art.

The pipe 30 is coupled to a first union 68 at the rear plate 24. Coating rehabilitation material and air are blown through the pipe 30, into the union 68 at a stationary portion of the union 68, and then out through a rotational portion of union 68 and into pipe or drive shaft 70. The first union 68 allows the pipe 30 to remain stationary while the pipe 70 is rotated by the motor 74, as will be described in detail below. The pipe 70 may be attached to the union and/or the base 20 through bearings 72. The bearing 72 may be ball bearings, or any other bearings known in the art that allow for smooth rotation of the pipe 70 while limiting the friction and thus the required size of the motor 74.

The water pipe 38 attaches to first union 68. The water is injected into union 68 at a stationary portion of union 68 and then is injected into a water hose 83 (see FIG. 5) out of the stationary portion of the union 68. The union 68 in this way allows material and water to enter in stationary portions with fixed inlets, with the material exiting the union within a rotating pipe 70, and the water exiting the union within a fixed water hose 83 for delivery to the delivery pipe 90.

FIG. 5 shows a forward view of the motor 74 and its attachments. The motor 74 is attached to plate 66 with a nut and bolt configuration, but may use any attachment means known in the art. An axle 80 may extend from the motor to a sprocket 78. A chain 76 may be coupled to the sprocket 78 on the axle 80, and coupled to a sprocket (not shown) on the pipe 70. In this way, rotational movement may be conveyed from the motor 74 to the pipe 70. The pipe 70 may be supported by a third bearing 72 at the front plate 22. In another embodiment, this rotation transfer may be accomplished without sprockets through a belt from the motor 74 to the pipe or drive shaft 70. In this way, the motor 74 controls the circumferential orientation of the delivery pipe 90 and the nozzle 100 through the pipe 70 which is coupled to the delivery pipe 90 and the nozzle 100.

FIG. 6 shows the front material delivery portion of the rehabilitation device 10. A second union 82 may be attached on a front side of front plate 22. The pipe 70 may be coupled to the union 82, which is in turn coupled to delivery pipe 90. In another embodiment, the pipe 70 and the delivery pipe 90 are integrally formed as a single pipe and fit through union 82. The water hose 83 is coupled to the union 82 on a stationary portion of the union 82 at a coupling or water inlet 84. The second union 82 allows for water to exit the union 82 at water outlet 86 and dry material rehabilitation material to exit the union 82 in delivery pipe 90 that are rotating, while material is coming in through a rotating pipe 70 and water is coming in through a stationary hose 83.

In another embodiment, the pipe 70 may be stationary and inject dry rehabilitation material into the stationary portion of union 82, which then directs the dry rehabilitation material to the rotatable delivery pipe 90. In this embodiment, the motor and sprockets may be disposed on the frame at a location forward of the base plate 22 to rotate the delivery pipe 90 directly.

The delivery pipe 90 and the water hose 88 both attach to the rotational portion of union 82, and rotate together as desired by the user. The delivery pipe 90 may include bends 92 and 94 which allow for the delivery of wetted rehabilitation material to a pipe at an angle perpendicular to the pipe wall. In other embodiments, the angles 92 and 94 may introduce wetted material to the pipe wall at any angle desired by the user. The delivery pipe 90 may be constructed such that angles 92 and 94 may also be remotely adjustable by the user to allow the user to apply material at different angles relative to the pipe wall.

The delivery pipe 90 may attach to a nozzle 100 assembly at a junction 96, and water may be introduced to the dry rehabilitation material through a dry gun mixing element or junction 98 at the nozzle 100. The direction that nozzle 100 faces is shown as stationary with respect to the pipe wall. In other embodiments, this angle may be remotely adjustable by the user, or may be programmed to follow a pattern that is optimized for the rehabilitation material being presented to the pipe wall, such as a circular motion that allows for a clean and uniform distribution of the material to the pipe wall. Or, the pattern may cause the rotatable delivery pipe 90 to spray back and forth through a predetermined angle, such between 70 degrees and 110 degrees when it is desirable to rehabilitate only the top of the underground pipe.

A camera 110 may be included on the rehabilitation device 10. The camera 110 may be attached to the nozzle 100 (see FIG. 6), the delivery pipe 90, the front plate 22 (see FIG. 1), or any other location that a user believes gives them the best view to see what areas to spray the wetted rehabilitation material. The locations of the camera 110 shown are exemplary only, and in other embodiments, the camera 110 may be located in any location that allows the user the best view of the location and orientation of the spray area. The camera 110 may be connected to a monitor that is accessible to the user at the remote location, allowing the user to see exactly where the material needs to be sprayed to be most effective. The camera 110 may have an air blade or a rolling film that allows for the camera lens to be free of dust and other material that may deposit on the camera lens and prevent the user from having a good view of the area being rehabilitated.

Turning back to FIG. 3, the base 20 may include a sled assembly 102 to allow the rehabilitation device 10 to be pulled, pushed, or driven through a pipe. The sled assembly 102 may include a leg 104 that is attached to the base 20 in a fashion known in the art, such as welding. The leg may attach to a runner 108. The runner 108 may include leg attachment pipes or legs 106 that extend away from the runner 108 and up to the leg 104. The leg attachment pipes may be adjustable such that the user may adjust how high the device 10 sits within the pipe. A winch may attach to the front of the device 10 to pull the device laterally through the pipe at a speed or to a specific location that the user desires. In other embodiments, the device is on wheels and pulled by the winch, or could have a separate, remotely controlled motor on at least one of the wheels to drive the device through the pipe.

The process for using the pipe rehabilitation device 10 is as follows. The rehabilitation device 10 is connected to a source of dry rehabilitation material at the pipe 30. The source of rehabilitation material includes both dry rehabilitation material and air pressure to push the rehabilitation material through a length of flexible hose to the device 10 wherever the device 10 may be located laterally within the pipe. The air pressure pushes the material all of the way out the nozzle and onto the inner wall of the underground pipe. A source of pressurized water is attached to the water pipe 38 at the water inlet 32. A valve and meter may be attached at the water inlet and set before insertion of the device 10 within the pipe to be rehabilitated. The pressure of both the water and the rehabilitation material in their respective pipes may be adjusted based on local conditions such as humidity, temperature, and ambient static air pressure. When it is desirable to cease operation, the rehabilitation material and water source are turned off first, but the air continues until all of the material is expelled from the nozzle. Wet material would cure if left in any line or pipe causing a clog. A winch line may be run through the pipe to be rehabilitated and connected to the front of the base 20, and electrical connections are made to the motor and camera 110, and any other remotely controlled aspects of the device 10 back to a remote control and monitor at the user's location.

After the device 10 is connected to all of its external sources, it is placed within the underground pipe to be rehabilitated or repaired. The user may use the camera 110 to decide on starting location within the pipe. Once the process is started, the dry material and air are urged through the stationary pipe 30 and into the union 68. The union 68 takes the material from the stationary pipe 30 and delivers it to the rotatable pipe 70. Water or other fluid under pressure are urged through pipe 38 and in an alternative embodiment combined in t-junction 42 with the water, other fluid, or potentially other chemical additions within pipe 46. The fluid from pipe 38 runs to and from the stationary portion of union 68 toward the front of the device 10.

The dry rehabilitation material then runs through the second union 82 and into the delivery pipe 90. The water exiting the union 68 in hose 83 is connected to the stationary portion of union 82 at the connection 84. This water then exits the rotatable portion of union 82 at the front of the front plate 22. As the still-dry rehabilitation material is urged through the delivery pipe 90 and toward the nozzle 100, the water travels through hose 88 parallel to (schematically) and rotates with the delivery pipe 90. The water is then fed into the nozzle 100 at junction 98, where the dry material is wetted in preparation for application to the pipe wall then expelled toward the pipe wall. In some embodiments the material is configured to cure and harden after is it mixed with the fluid. In these embodiments the wetted material cures and hardens after application to the pipe wall.

In still other embodiments, the dry rehabilitation material may be mixed with the wet curing agent or water at a location before the delivery pipe 90. For instance, the wet and dry materials may be mixed in the rotatable pipe 70, or the wet and dry materials may be mixed at the dry material inlet pipe 30. In any case, it is advantageous to delay the mixing of the wet material with the dry rehabilitation material as long as possible to enjoy the benefits of delivering the rehabilitation material in its dry state over longer distances than already-wetted material.

The user may adjust the pressure of the dry material, the wetting fluid or both depending on the application and local weather conditions, and based on what the user sees on the camera 110 from the remote location. For instance, a user may desire to have more material added in certain positions within the pipe, and increase the air pressure in the material pipe, the water pressure of the water pipe, or both. Each of these pressures is independently sensed and controlled by the user.

The user or a second user can urge the entire device 10 through the pipe to be rehabilitated using the remote winch control which pulls the device 10 longitudinally through the pipe at a desired speed. This longitudinal speed may be increased or decreased, and the rotation speed of the nozzle may be increased or decreased based on external conditions, changing conditions of the pipe wall, differences in shape of the pipe wall, or a combination of the three in any combination. For instance, a pipe may be corrugated and require the nozzle to remain in one spot for more time in places where the corrugation is at a low spot, or the user may keep the speeds constant in a pipe that is smooth or even. All of this user control is available from a position that is remote from the area being rehabilitated.

After the application of the material to the pipe walls, the device 10 is then pulled or driven back out of the pipe. In order to ensure that the external lines that are attached to the device 10 do not gather up and kink and prevent the device from extraction from the pipe, a centralizer may be used to guide the lines out of the pipe in an orderly fashion. Alternatively, a reel may be located outside of the pipe that pulls the lines and stows them to keep them out of the way of the extracting device 10.

In another embodiment, the water line bypasses the first union 68 altogether and is directly attached to the second union 82. In another embodiment the dry material is directly attached to the stationary portion of second union 82. In another embodiment, the pipe 70 is directly attached to the shaft 80 at the front of the motor, without needing a chain or belt. All of these attachments may be combined in any order without deviating from the scope of the disclosure.

The material applied to the pipe wall may be a non-structural surface coating such as a curing agent or an antibacterial agent. These types of surface coatings may be mixed with structural materials (such as cementitious materials or polymers) before application through the spin caster so that the resultant material applied to the pipe wall is a mixture of structural and non-structural materials. In other embodiments non-structural surface coatings are applied after the upper coating is formed. For example, a curing compound can be applied to the uncured material after it has been sprayed onto the pipe wall to prevent shrinkage cracking. Another example, before or after the lower layer is added, an antibacterial agent can be applied to the upper layer, above the water line, to effectively prevent MIC and eliminate Thiobacallius bacteria on contact, and thereby prevent or minimize corrosion of the upper coating 16 layer. Thiobacallius bacteria metabolizes to convert oxygen and hydrogen gas into sulfuric acid, which quickly erodes or dissolves concrete and other materials. Therefore, application of an antibacterial agent will prevent or minimize such deterioration. One commercial antibacterial product is CON(MIC)SHIELD sold by Action Products Marketing Corp. CON(MIC)SHIELD is an EPA registered antibacterial agent that molecularly bonds to concrete, and will not wash off, peel off, delaminate, or pinhole. Some types of non-structural surface coatings such as CON(MIC)SHIELD can only be used in sanitary sewers due to environmental regulations.

In using the device in the manner as disclosed above, a pipe rehabilitation device 10 is able to be used in a single instance for a much longer lateral distance without having to remove, disconnect, move, reconnect and restart the process. In urging wetted material through a conduit and to a rehabilitation device the user is limited to rehabilitating approximately 500 lineal feet of lateral distance of pipe. By urging dry material through the conduit and only wetting the material at the nozzle 100, users may enjoy the ability to rehabilitate 3000-5000 lineal feel of lateral distance of pipe in a single instance. This reduces the number of times the device must be removed, disconnected, moved, reconnected, and restarted significantly reducing the cost and time associated with pipe rehabilitation.

Further, by using dry rehabilitation material through the pipe, more material is able to be applied to the pipe wall in a single pass. Because there is little to no degradation or premature curing of the material between the source and application, not only can a longer length of pipe be rehabilitated in a single pass, but users can spend longer time in any given position within the pipe, ensuring that the pipe is completely rehabilitated in the one pass.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. A controllable pipe rehabilitation device comprising:
a base;
a first water inlet configured to receive water from a water source;
a dry pipe rehabilitation material inlet configured to receive a dry pipe rehabilitation material;
a hollow pipe disposed on the base and coupled to the dry pipe rehabilitation material inlet, the hollow pipe configured to guide rehabilitation material from the inlet through the base;
a rotatable delivery pipe coupled to the hollow pipe at a proximal end and having a nozzle at a distal end;
a motor disposed on the base and configured to controllably rotate the rotatable delivery pipe;
a union disposed between the base and the nozzle, the union including a stationary water inlet, and a water outlet configured to rotate with the rotatable delivery pipe;
a first hose configured to guide water received at the first water inlet to the stationary water inlet; and
a second hose configured to rotate with the rotatable delivery pipe and guide water from the water outlet to the rotatable delivery pipe, the second hose configured to introduce and mix water with the dry rehabilitation material within the rotatable delivery pipe.

2. The controllable pipe rehabilitation device of claim 1, further comprising a camera disposed on the delivery pipe.

3. The controllable pipe rehabilitation device of claim 2, further comprising a monitor operably connected to the camera and configured to allow a user to see the area being rehabilitated remotely.

4. The controllable pipe rehabilitation device of claim 1, further comprising a drive wheel disposed on the base and operably coupled to the remote control, such that a user may control a lateral position of the remotely controllable pipe rehabilitation device within a pipe to be rehabilitated.

5. The controllable pipe rehabilitation device of claim 4, further comprising a plurality of wheels disposed on the base.

6. The controllable pipe rehabilitation device of claim 1, further comprising a water flowmeter configured to display the rate of water use by the device.

7. The controllable pipe rehabilitation device of claim 1, wherein the motor further comprises a first sprocket, and wherein the hollow pipe is rotatably attached to the base and further includes a second sprocket coupled to the first sprocket, the hollow pipe coupled to and rotatable with the rotatable delivery pipe.

8. The controllable pipe rehabilitation device of claim 1, further comprising a remote control disposed remotely from the area to be rehabilitated, the remote control configured to allow a user to operably maneuver the motor into a desired orientation.

9. The controllable pipe rehabilitation device of claim 1, wherein the rotatable delivery pipe further comprises a nozzle, and the second hose is configured to introduce and mix water with the dry rehabilitation material within the nozzle of the rotatable delivery pipe.

10. A device for applying a pipe rehabilitation material, comprising:
a pipe configured to be connected to a source of dry pipe rehabilitation material, the pipe configured to guide an amount of the dry pipe rehabilitation material through the device;
a delivery pipe coupled to the front end of and rotatable with the drive shaft, the delivery pipe terminating with a nozzle;
a motor operably coupled to the delivery pipe and configured to controllably rotate the delivery pipe;
a union having a fixed portion and a rotatable portion, wherein the rotatable portion rotates with delivery pipe;
a water inlet disposed on the stationary portion of the water union and configured to be connected to a source of water;
a water outlet disposed on the rotatable portion of the water union; and
a hose having a hose inlet at the water outlet and a hose outlet on the delivery pipe and configured to introduce water to the amount of dry rehabilitation material.

11. The device of claim 10, further comprising a camera attached to the device.

12. The device of claim 11, wherein the camera is operably coupled to a monitor that is remote from the area to be rehabilitated.

13. The device of claim 10, wherein the motor is a first motor, and further comprising a second motor coupled to a drive wheel.

14. The device of claim 13, wherein the second motor is remotely controllable from the area being rehabilitated.

15. The device of claim 14, further comprising a plurality wheels disposed on a bottom of the device.

16. The device of claim 10, wherein the pipe is a drive shaft, the device further comprising:
a drive sprocket operably coupled to the motor;
a second sprocket operably coupled to the drive shaft; and
a chain disposed between the drive sprocket and the second sprocket.

17. The device of claim 10, wherein the drive shaft and the applicator pipe are a single piece.

18. The device of claim 10, wherein the applicator pipe is bent such that the nozzle points in a direction substantially perpendicular to an axis of rotation of the drive shaft.

19. The device of claim 10, wherein the pipe is a drive shaft that is coupled to the delivery tube, and the motor is configured to controllably rotate the drive shaft and the delivery tube.

20. A method of applying a pipe rehabilitation material to an inside of a pipe, comprising the steps of:
blowing a dry pipe rehabilitation material into a rotatable delivery pipe using an amount of pressurized air;
wetting the dry pipe rehabilitation material by combining a fluid with the dry pipe rehabilitation material within the rotatable delivery pipe;
controllably rotating the delivery pipe by a motor disposed on a frame of a rehabilitation device;
applying the wetted pipe rehabilitation material to the inside of the pipe.

21. The method of claim 20, wherein the controllably rotating step is accomplished by coupling the motor to a drive shaft that is operably coupled to the delivery tube.

22. The method of claim 21, wherein the motor is remotely controlled by a user located remote from the area of the pipe being rehabilitated.

23. The method of claim 20, wherein the applying the wetted pipe rehabilitation material step is applied to the inside of the pipe at a first rotational speed, and further comprising the step of applying the wetted pipe rehabilitation material to the inside of the pipe at a second rotational speed.

24. The method of claim 20, further comprising step of:
remotely viewing the inside of the pipe to be rehabilitated on a monitor that is operably connected to a camera disposed on the delivery pipe.

25. The method of claim 24, further comprising the step of:
remotely controlling the lateral position of the delivery pipe by urging a drive wheel attached to the delivery pipe using a motor operably connected to the remote control.

26. A remotely controllable pipe rehabilitation device comprising:
a base;
a first water inlet configured to receive water from a water source;
a dry pipe rehabilitation material inlet configured to receive a dry pipe rehabilitation material;
a rotatable delivery pipe coupled to the hollow pipe at a proximal end and having a nozzle at a distal end, the rotatable delivery pipe configured to deliver a mix of the water from the water source and the dry pipe rehabilitation material from the dry pipe rehabilitation material inlet to a portion of a pipe needing rehabilitation;
a union disposed on the base and configured to deliver dry pipe rehabilitation material from the dry pipe rehabilitation material inlet and water from the water source to the rotatable delivery pipe;
a motor disposed on the base and configured to controllably rotate the rotatable delivery pipe;
wherein the motor is controllable by a user control at a location remote from the portion of a pipe needing rehabilitation.

27. The remotely controllable pipe rehabilitation device of claim 26, further comprising a camera disposed on the delivery pipe.

28. The remotely controllable pipe rehabilitation device of claim 27, further comprising a monitor operably connected to the camera and configured to allow a user to see the area being rehabilitated remotely.

29. The remotely controllable pipe rehabilitation device of claim 26, further comprising a drive wheel disposed on the base and operably coupled to the remote control, such that a user may control a lateral position of the remotely controllable pipe rehabilitation device within a pipe to be rehabilitated.

30. The remotely controllable pipe rehabilitation device of claim 29, further comprising a plurality of wheels disposed on the base.

31. The remotely controllable pipe rehabilitation device of claim 26, further comprising a water flowmeter configured to display the rate of water use by the device.

32. The remotely controllable pipe rehabilitation device of claim 26, further comprising:
a first hose configured to guide water received at the first water inlet to a stationary water inlet disposed on the union; and
a second hose configured to rotate with the rotatable delivery pipe and guide water from the water outlet to the rotatable delivery pipe, the second hose configured to introduce and mix water with the dry rehabilitation material within the rotatable delivery pipe.
